(19) United States
(12) Patent Application Publication
(10) Pub. No.: US 2017/0218986 A1
(43) Pub. Date: Aug. 3, 2017

(54) Profiled Element for Generating a Force

(71) Applicant: Remi LAFOREST, Boucherville (CA)

(72) Inventor: Remi LAFOREST, Boucherville (CA)

(21) Appl. No.: 15/500,662

(22) PCT Filed: Sep. 24, 2015
(86) PCT No.: PCT/IB2015/057362

§ 371 Date: Jan. 31, 2017

(30) Foreign Application Priority Data
Nov. 25, 2014 (CA) 2,872,375

(51) Int. Cl. F15D 1/00; F15D 1/06

(52) U.S. Cl. CPC F15D 1/0045; F15D 1/06; B64C 2230/26; B63B 1/36

(57) ABSTRACT

A profiled element used is disclosed for generating a force, the profiled element comprising a material having an active surface; a plurality of cavities located on the active surface of the material, the plurality of cavities comprising pin holes, each pin hole having an opening of a micrometric size on the active surface and a depth of a micrometric size greater than its diameter; wherein each pin hole is hermetically sealed on the opposite side of the cavity; and further wherein an airflow circulation against the active surface of the material causes a pressure change on the active surface and inside each of the plurality of cavities thereby generating a force.

### CROSS-REFERENCE TO RELATED APPLICATION

The present patent application claims priority on Canadian Patent Application No. 2,872,375, filed on Nov. 25, 2014, by the present applicant, the subject matter of which is incorporated herein by reference.

### FIELD

The invention relates to materials. More precisely, the invention pertains to a profiled element for generating a force in an airstream.

### BACKGROUND

Prior-art airplanes have been generating air lift through the flow of air around concave-shaped wings, which mainly force air on a longer path over the wings than under them, creating air rarefication over the wings, which generates a lift on the wings.

In the case of helicopters, rotating blades generate an air lift.

Prior-art gliders and wingsuits exploit air currents and rely on aerodynamic shapes for air lifts.

Prior-art aeronautic designs are based on aerodynamic airflows that are very much affected by atmospheric conditions.

Features of the invention will be apparent from review of the disclosure, drawings and description of the invention below.

### BRIEF SUMMARY

According to one aspect, there is disclosed a profiled element used for generating a force, the profiled element comprising a material having an active surface; a plurality of cavities located on the active surface of the material, the plurality of cavities comprising pin holes, each pin hole having an opening of a micrometric size on the active surface and a depth of a micrometric size greater than its diameter; wherein each pin hole is hermetically sealed on the opposite side of the cavity; and further wherein an airflow circulation against the active surface of the material causes a pressure change on the active surface and inside each of the plurality of cavities thereby generating a force.

In accordance with an embodiment, the active surface is moving and is facing upwardly and the force generated is a lifting force oriented away from the active surface.

In accordance with an embodiment, an active surface is facing downwardly and the force generated is a lifting force oriented toward the active surface.

In accordance with an embodiment, the active surface is substantially perpendicular to a horizontal plane and the force is a propelling force.

In accordance with an embodiment, the plurality of cavities comprise undulated groove cavities and the undulated groove cavities have a shape of a sinusoidal.

In accordance with an embodiment, the profiled element is in the form of surface micro irregularities made of protrusions and recesses.

In accordance with an embodiment, the undulated groove cavities have an average crest-to-crest distance of 15 microns for relative speed comprised between 250 km/h and 400 km/h.

In accordance with an embodiment, the undulated groove cavities have an average crest-to-crest distance comprised between 15 and 50 microns for relative speed comprised between 400 km/h and 700 km/h.

In accordance with an embodiment, the undulated groove cavities have an average crest-to-crest distance of 50 microns for relative speed greater than 700 km/h.

In accordance with an embodiment, the undulated groove cavities have a depth of 20 microns.

In accordance with an embodiment, the ratio of openings of the pin holes cover 50% of the active surface.

In accordance with an embodiment, at least one pin hole has an opening with a diameter value ranging from 0.2 to 1 micron for a relative speed comprised between 5 km/h and 60 km/h.

In accordance with an embodiment, at least one pin hole has an opening with a diameter value ranging from 1 to 10 microns for a relative speed comprised between 60 km/h and 250 km/h.

In accordance with an embodiment, at least one pin hole has an opening with a diameter value ranging from 10 to 15 microns for a relative speed comprised between 250 km/h and 400 km/h.

In accordance with an embodiment, the airflow circulation is caused by a motion of the profiled element.

In accordance with an embodiment, the airflow circulation is caused by air being forced against the active surface.

In accordance with an embodiment, there is disclosed a wingsuit comprising a profiled element.

In accordance with an embodiment, there is disclosed an airplane comprising a profiled element.

In accordance with an embodiment, there is disclosed an aircraft comprising a rotating disk comprising the profiled element.

The profiled element may be used advantageously in an aircraft for streamlining the wings and for increasing lift, thereby reducing the impact of air drag, decreasing fuel consumption, decreasing takeoff and landing speeds and using shorter runways.

The profiled element may be used advantageously in a wingsuit and in a prior-art glider for increasing gliding performance.

### BRIEF DESCRIPTION OF THE DRAWINGS

In order that the invention may be readily understood, embodiments of the invention are illustrated by way of example in the accompanying drawings.

FIG. 1a is a diagram which shows a crossed-sectioned view of a pin hole cavity illustrating how a force is generated by moving the active surface through the air as applied for instance to airplane wings and fuselage.

FIG. 1b is a diagram which shows a crossed-sectioned view of a pin hole cavity illustrating how a force is generated by injecting an air stream against the active surface or by rotating a disk active surface in ambient air.

FIG. 2a is a diagram which shows a 3D perspective view of an embodiment of a profiled element which illustrates an embodiment in which the profiled element comprises a plurality of pin hole cavities.

FIG. 2b is a diagram which shows a crossed-sectioned view of the profiled element shown in FIG. 2a.

FIG. 3a is a diagram which shows a 3D perspective view of another embodiment of a profiled element which illustrates an embodiment in which the profiled element comprises a plurality of pin hole cavities and undulated grooves.

FIG. 3b is a diagram which shows a crossed-sectioned view of the profiled element shown in FIG. 3a.

FIG. 4 is a diagram which shows a 3D perspective view of an embodiment of an aircraft. In this embodiment, the aircraft comprises the profiled element at various locations.

FIG. 5a is a diagram which shows a 3D perspective view of an embodiment of two concentric disks, each disk comprising the profiled element, each adjacent disk rotating in an opposite direction.

FIG. 5b is a diagram which shows a 3D perspective view of a portion of a concentric disk of the two concentric disks shown in FIG. 5a which shows a plurality of pin hole cavities and undulated grooves.

FIG. 6a is a diagram which shows an embodiment of a wingsuit comprising an embodiment of the profiled element.

FIG. 6b is a diagram which shows an enlarged 3D perspective view of one part of the profiled element located on the wingsuit shown in FIG. 6a wherein the enlarged view shows a plurality of pin hole cavities.

Further details of the invention and its advantages will be apparent from the detailed description included below.

### DETAILED DESCRIPTION

In the following description of the embodiments, references to the accompanying drawings are by way of illustration of an example by which the invention may be practiced.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “i.e.” and like terms mean “that is,” and thus limit the terms or phrases they explain.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

With all this in mind, the present invention is directed to a profiled element used for generating a force.

As further disclosed below, the profiled element may be used in various applications. For instance, the profiled element may be used in airplanes, helicopters, gliders and wingsuits. The skilled addressee will appreciate that the profiled element may be further used in other applications.

It will be appreciated that, in one embodiment, the force generated may be used as a propelling force for propelling or assisting the propelling of an assembly.

In an alternative embodiment, the force generated may be used as a lifting force for lifting or assisting the lifting of an assembly.

The profiled element comprises a material having an active surface and a plurality of cavities located on the active surface of the material.

It will be appreciated that the material may be of various types. In one embodiment, the material is selected from a group consisting of metal plates or sheets, graphite, composite material, polymer, plastic, canvas or any other suitable material as further explained below.

In one embodiment, the material is titanium powder sintered to form a metal plate.

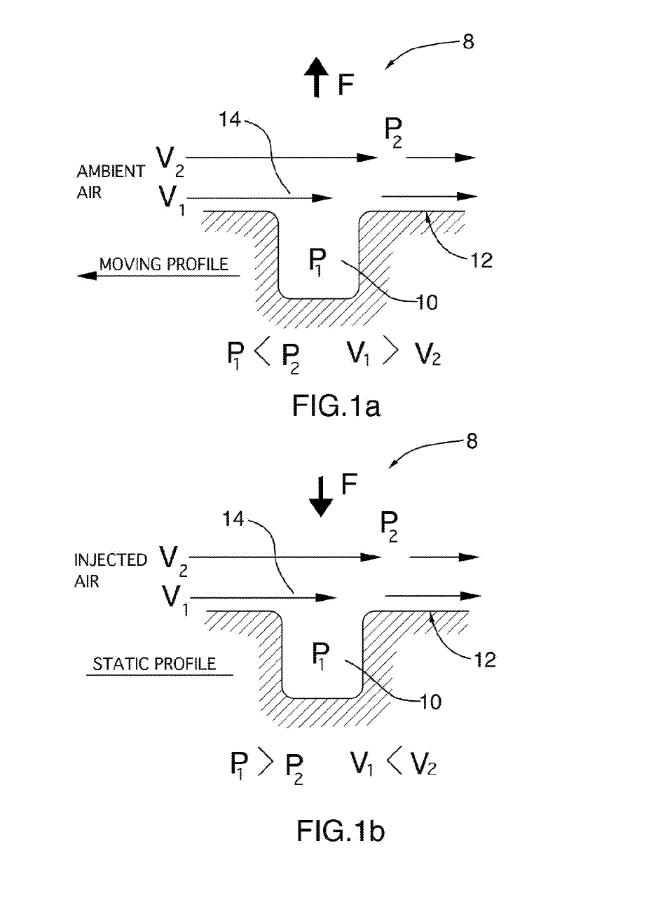

Now referring to FIG. 1a and FIG. 1b, there is shown how the force is generated in various embodiments. For the sake of clarity and conciseness, a single pin hole cavity 10 is illustrated in FIG. 1a and FIG. 1b. Moreover, it will be appreciated that in these embodiments, the force may be a lifting or a propelling force depending on the positions of the active surface as facing upward, downward or vertically.

The pin hole cavity 10 is located on an active surface 12 of the profiled element 8.

It will be appreciated that the pin hole cavity 10 has typically a pin hole opening size and a depth of a micrometric size.

It will be appreciated that when there is no airflow against the active surface 12 of the profiled element 8, a pressure P1 measured on the surface and inside the pin hole cavity 10 is equal to a pressure P2 measured above the active surface 12 of the profiled element 8.

However, when an active surface is moved through ambient air, the film of air against the active surface flows at a greater relative speed to the active surface than the air above it, creating, as supported by the Bernoulli Principle, a change in pressure and a lift on the surface and in the pin hole cavity 10, as found on applications onto airplane wings and fuselage.

It will be appreciated that the motion of air may be created by any one of the motion of the profiled element 8 in ambient air and by generating an airstream against the active surface 12.

However, when an airstream flows against an active surface or when an active surface is rotated in ambient air, the relative speed between the surface and the air film against that active surface is less than the speed of the airstream immediately adjacent to the air film. Thus, as supported by the Bernoulli Principle, the pressure is greater on the surface and the force is directed toward the active surface. In such cases, the active surface has to be installed in the horizontal plane facing downward to produce a lifting force and in a vertical plane to produce a propelling force.

The lifting force may be partly explained by the Bernoulli Principle that states that “faster moving air has a lower pressure than slower moving air” as formulated in P₁<P₂ when V₁>V₂, which is why the force generated on a moving profiled element is oriented opposite to the force generated by an airstream injected against the profiled element. The film of air passing against a moving profiled element is greater than adjacent ambient air. But, when air is injected over the profiled element, it is slowed by the active surface resistance, thus the air film against the active surface is slower than the injected air stream as formulated in P₁>P₂ when V₁<V₂.

Furthermore, the Bernoulli Principle covers only incompressible fluids. Thus, in association with the Bernoulli Principle, there are hereinafter two additional equations developed from other fundamental principles of physics applicable to compressible fluids, such as the air. The resulting equations are applicable in part to the lifting force created on the profiled element, and are:

V²/2+{ [symbol] / [symbol] −1}p/ρ={ [symbol] / [symbol] −1}p₀/ρ₀

∂φ/∂t+1/2v²+p/ρ+gz=f(t) where f=V²/2+Ψ+p/ρ
Flow velocity=V (Gradient▾φ)
Specific heat ratio= [symbol]
Velocity potential=φ
Acceleration of gravity=g
Point elevation on plane=z (pointing up)
Pressure=p
Total pressure=p₀
Density=ρ
Total density=ρ₀
Related to time, not on position in fluid=ft
Constant=f
Time for whole domain=t
Force of gravity=Ψ

However, the skilled addressee will appreciate that those equations do not cover all the factors involved in the creation of a lifting force on the profiled element, which also includes dynamic lift, momentum transfer, process of entrainment, Luke's variational principle and pilot-wave dynamics, which are too complex to be derived by calculation alone due to variations in the micro structures, the forms and orientations of the profiled element.

As a consequence, the pressure P2 over the active surface 12 becomes greater or smaller than the pressure P1 against the profiled element and inside the pin hole cavity 10, depending on the relative speed between the air film at the active surface V1 and the air V2 immediately adjacent to the air film.

The gradient of pressure P2-P1 generates a force F. The force F will assist the lifting or propelling of the profiled element 8.

It will be appreciated that the extent of the pressure change on the profiled element and in the pin hole cavity 10 may depend on various parameters such as a pin hole cavity opening size, a pin hole cavity depth, surface ratio of pin hole cavity openings versus non pin hole, surface ratio of mean surface versus mean undulated cavities of the grooves and the relative speed between the active surface and the air film against the active surface and the relative speed differential between the air film against the active surface and the airstream adjacent to it.

While this has not been shown on FIG. 1a and FIG. 1b, it will be appreciated that the pin hole cavity 10 is hermetically sealed on the opposite side of the pin hole cavity 10 such that air can enter or exit the pin hole cavity 1 on the active surface 12 using only its opening 14.

It has been contemplated that a pin hole cavity size of 0.2 micron provides an optimum lifting force at a relative speed of 5 km/h.

The pin hole cavity opening size may be gradually increased to 10 microns as the relative speed of the air film against the profiled element increases to 250 km/h.

The pin hole cavity opening size increases from 10 to 15 microns as the relative speed of the air film against the profiled element increases from 250 to 400 km/h. It will be appreciated that, in order to achieve an optimum lifting force, the pin hole cavities may be combined with undulated grooves.

It has been contemplated that when the relative speed of the air film flowing against the profiled element is above 400 km/h, the pin hole cavities have a decreasing effect on the generation of the lifting force; thus, undulated grooves are sufficient for producing the lifting force.

It has been contemplated that the minimum depth of the pin hole cavity is to be equal to the size of the pin hole cavity, in one embodiment, in order to generate an optimum lifting force.

The thickness and type of material used for manufacturing the profiled element 8 are determined by the strength and the resistance of material needed for the application.

It has been contemplated that the intensity of the lifting force increases generally with the ratio of pin hole cavity openings versus non pin hole active surface on the profiled element 8. It has been contemplated that an optimum lifting force is obtained at a ratio of 50%.

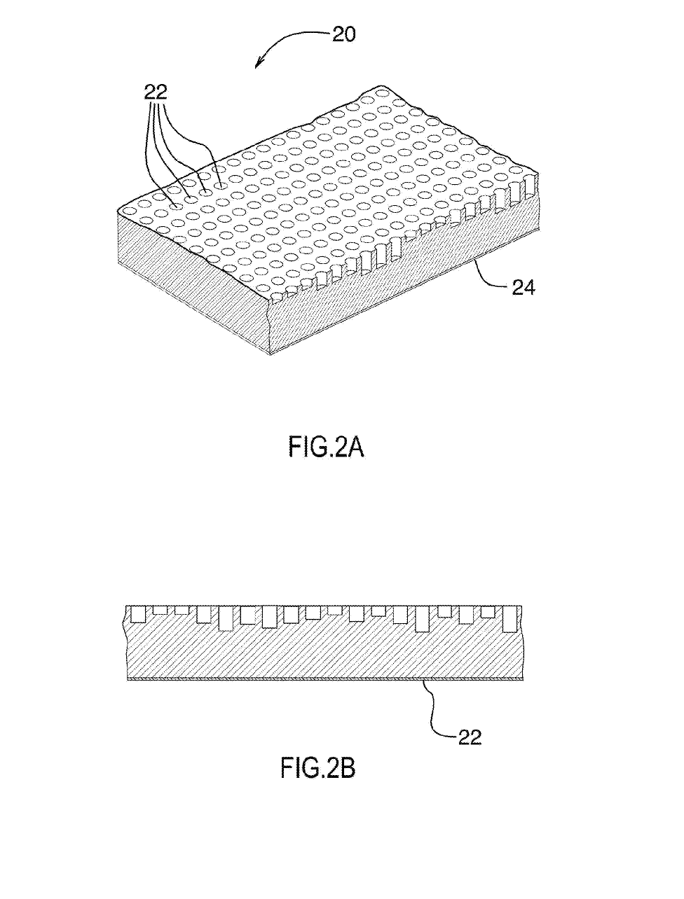

Now referring to FIGS. 2a and 2b, there is shown a profiled element 20 which illustrates an embodiment in which the profiled element comprises a plurality of pin hole cavities, for instance, cavities 22.

It will be appreciated that the plurality of cavities may have a different depth.

The skilled addressee will appreciate that various alternative embodiments may be possible.

As mentioned above, it will be appreciated that the plurality of cavities may be manufactured according to various embodiments.

As mentioned above, it will be appreciated that each pin hole cavity is hermetically sealed on the opposite side of the pin hole cavity such that air can enter or exit the pin hole cavity on the active surface using only its opening. In one embodiment shown in FIGS. 2a and 2b, the sealing is performed using layer 24.

In one embodiment, the layer 24 is made of a heavy coat of resistant paint or coating.

In an alternative embodiment, the cavities are hermetically sealed on the opposite side of the cavity opening through manufacturing, which do not open on the opposite side of the element.

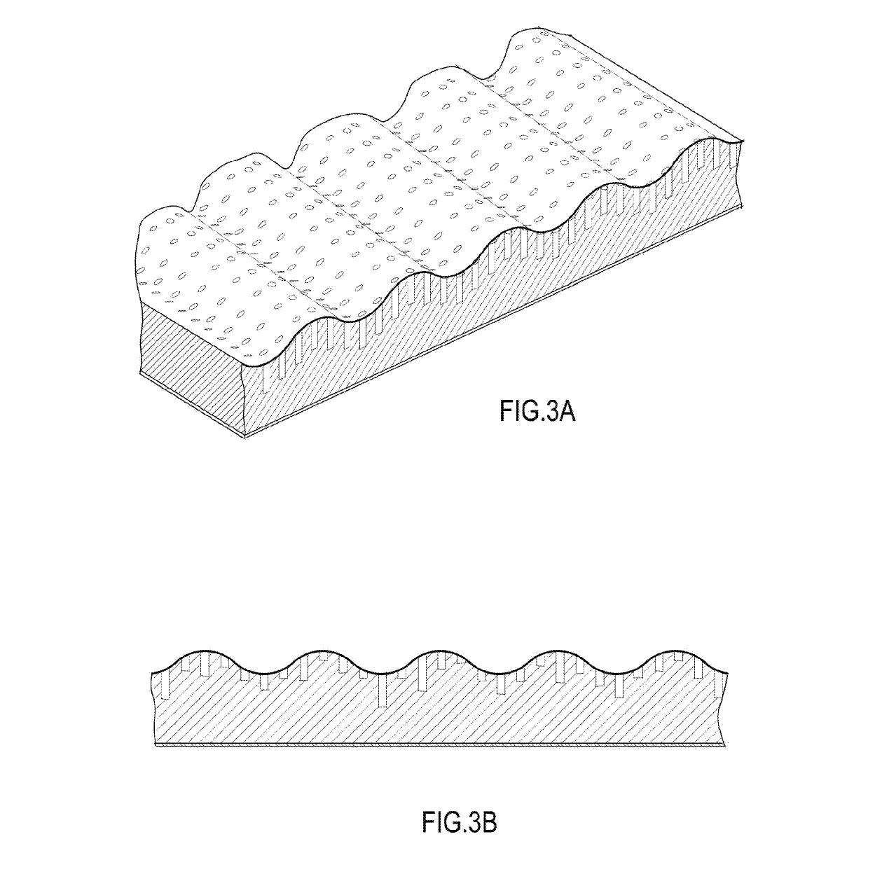

Now referring to FIG. 3a, there is shown a profiled element which illustrates an embodiment in which the profiled element comprises a plurality of cavities. The plurality of cavities comprises pin hole cavities and also undulated groove cavities.

The undulated groove cavities have a shape of a sinusoidal form preferably oriented across the flow of air in one embodiment.

The skilled addressee will appreciate that the undulated groove cavities may have various alternative shapes.

In another alternative embodiment, the undulated grooves are made of irregularities on the surface in the form of micro protrusions and recesses.

It will be appreciated that the undulated grooves act in a fashion similar to the pin hole cavities. In the case of an undulated groove, a gradient of pressure is created between the bottom of the undulated recess and the top. The gradient of pressure generates a force causing the profiled element to be lifted or propelled in the direction of the force.

It has been contemplated that, for relative speed between the air film and the active surface that are comprised between 250 and 400 km/h, an optimum average crest-to-crest distance is about 15 microns.

It will be appreciated that the optimum average crest-to-crest distance may increase from 15 microns to 50 microns as the relative speed between the air film and the active surface increases from 400 km/h to supersonic speeds.

Moreover, it has been contemplated that an optimum average crest-to-crest distance will be 50 microns for relative speeds greater than 700 km/h.

It has been further contemplated that an optimum depth of the undulated groove cavities was 20 microns at all relative speeds.

It will be appreciated that, as shown in FIG. 3b, the depth of the pin hole cavities may also vary from one another, as this is also the case with FIGS. 2a and 2b.

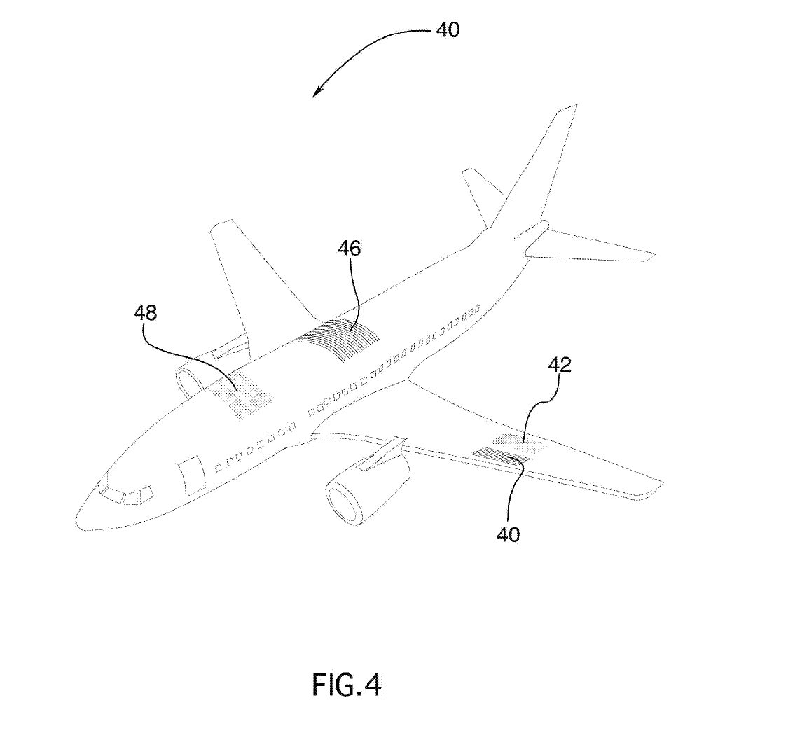

Now referring to FIG. 4, there is shown a first embodiment in which the profiled element may be used.

In this embodiment, the profiled element is used on an aircraft 40.

In this embodiment, the purpose of using the profiled element is to increase the lift of the aircraft 40.

It will be appreciated that the profiled element may be provided as sheets that are located on the upper part of the wings of the aircraft 40 and on the upper part of the fuselage of the aircraft in one embodiment. The purpose of providing the profiled element on the upper part is that the force created will be directed upwardly.

More precisely, a first profiled element 42 is located on an upper part of the wing of the aircraft 42. In this embodiment, the first profiled element 42 is comprised of a plurality of pin hole cavities.

A second profiled element 44 made of a plurality of undulated grooves is also located on an upper part of the wing of the aircraft 42.

A third profiled element 46 is located on the top surface of the fuselage.

In this embodiment, the third profiled element 46 is made of undulated grooves.

A fourth profiled element 48 is located on the upper part of the fuselage.

In this embodiment, the fourth profiled element 48 is made of a plurality of pin hole cavities.

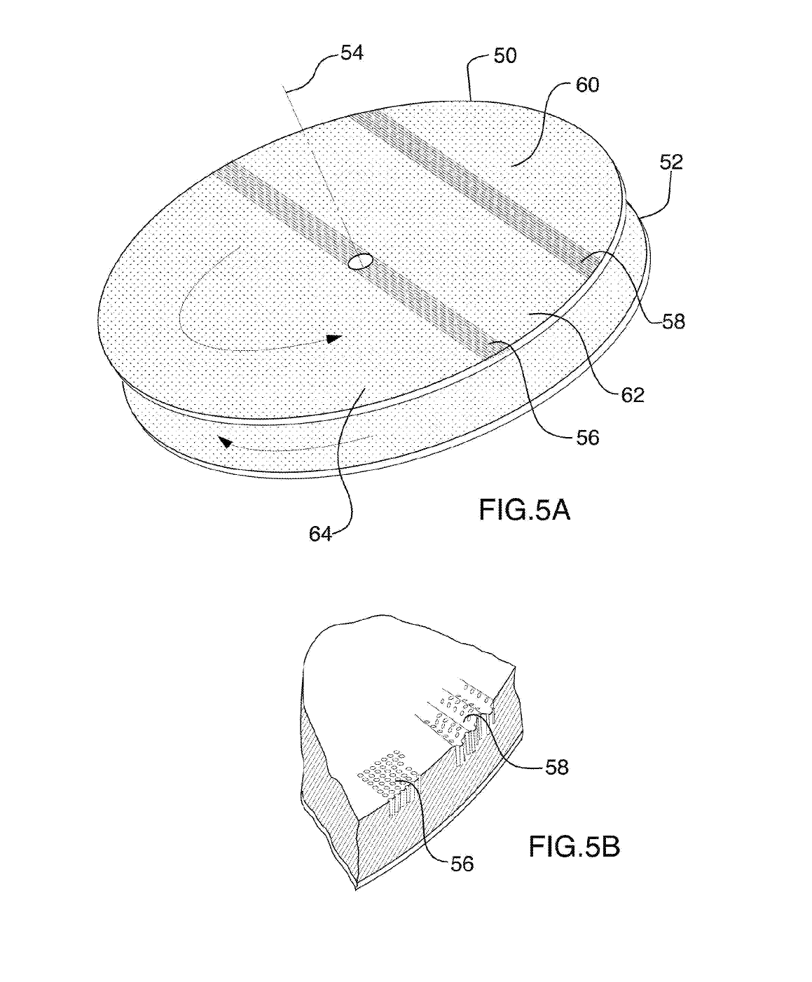

Now referring to FIG. 5a, there is shown an embodiment of two concentric disks, each disk comprising an embodiment of a profiled element.

In a first embodiment, each disk is rotating in an opposite direction. In a second embodiment, the disks or active surface are not rotating, i.e., they are static.

It will be appreciated that the rotating disks or static active surface may be housed inside the body of an aircraft and may be protected against hovering collisions.

In accordance with the first embodiment, a first disk 50 is rotating counterclockwise around axis 54 while a second disk 52 is rotating clockwise around the axis 54.

It will be appreciated that the first disk 50 and the second disk 52 may be rotated according to various embodiments.

In one embodiment, the first disk 50 and the second disk 52 are rotated using a motor and proper transmission gear.

As shown in FIG. 5a, the first disk 50 comprises a first profiled element 56 comprising a plurality of cavities. The plurality of cavities of the first profiled element 56 comprises a plurality of pin hole cavities and a plurality of undulated grooves.

The first profiled element 56 is centered radially on the first disk 50.

The first disk 52 comprises a second profiled element 58 comprising a plurality of cavities. The plurality of cavities of the second profiled element 58 comprises a plurality of pin hole cavities and a plurality of undulated grooves.

The first disk 52 further comprises a third profiled element 60, a fourth profiled element 62 and a fifth profiled element 64.

Each of the third profiled element 60, the fourth profiled element 62 and the fifth profiled element 64 comprises a plurality of cavities which are pin hole cavities.

It will be appreciated that the rotating of the first disk 52 and the second disk 54 will create a force that will cause an assembly rotatably mounted to the first disk 52 and to the second disk 54 to be lifted.

It will be appreciated that for hovering aircraft equipped with the first disk 52 and the second disk 54 rotating at linear speed ranging from 30 to 120 km/h, the active surface is provided with pin hole openings of 1 to 4 microns. Considering that the linear speed changes along the radius of a rotating disk, the speed is measured on the outer half section of the disk radius. The ascent and the descent of the hovering aircraft are controlled using the rotation speed of the rotating disks.

In a second embodiment, the disks or profiled plates do not rotate and the surface is blasted with air jet induced airstream in order to generate a lifting force. In this second embodiment, the active surface of the disks is provided with pin hole openings of 1 to 4 microns. The hovering aircraft ascent and descent are controlled by controlling the air jet induced airstream on the surface of the disks and the profiled plates.

It will be appreciated that alternatively the first disk 52 and the second disk may be used to propel the assembly provided that the first disk 52 and the second disk 54 are placed in a plane substantially perpendicular to a horizontal plane and with the disks in the same plane.

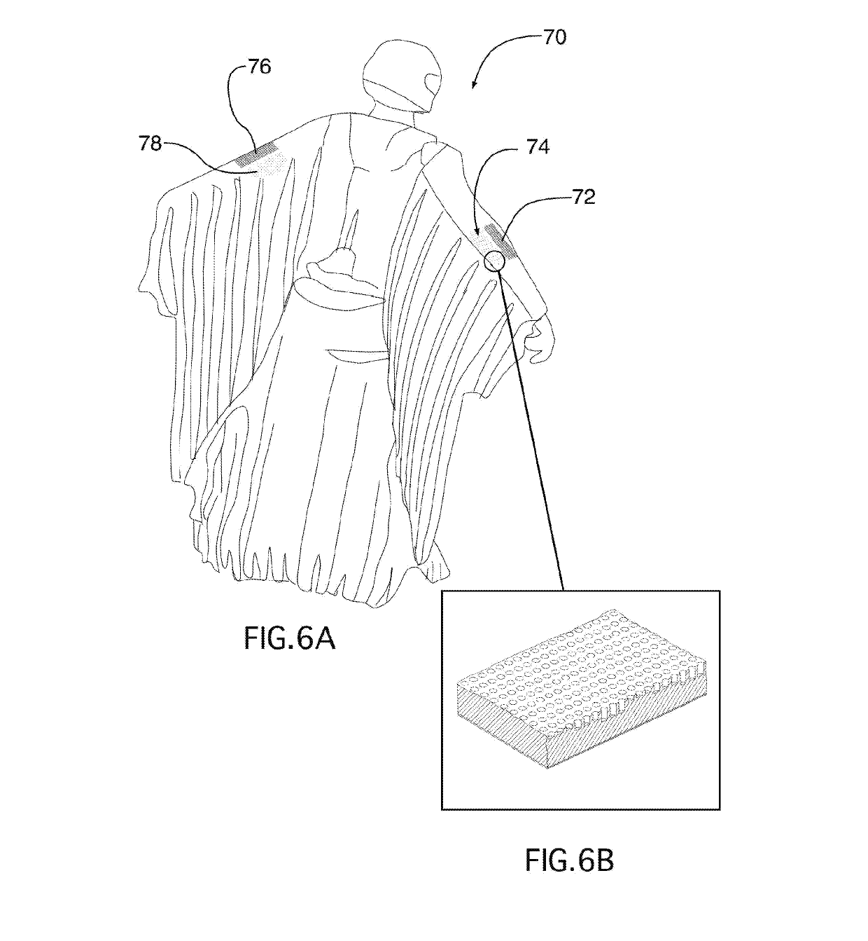

Now referring to FIG. 6a, there is shown an embodiment of a wingsuit 70 comprising an embodiment of the profiled element located on it.

The purpose of using the profiled element in the wingsuit is to enhance its performance in terms of gliding capacity.

In this embodiment, the wingsuit 70 comprises a first profiled element 72, a second profiled element 74, a third profiled element 76 and a fourth profiled element 78.

Each of the first profiled element 72, the second profiled element 74, the third profiled element 76 and the fourth profiled element 78 are located on the arm extension and between the leg portions of the wingsuit 70.

In this embodiment, the first profiled element 72 and the third profiled element 76 comprise cavities. The cavities comprise undulated grooves and or pin hole cavities.

It will be appreciated that, in one embodiment, the profiled element used for the wingsuit may be made of canvas, textile or flexible plastic with pin hole cavities ranging in diameter from 0.2 to 1 micron at linear speeds of 5 to 60 km/h. At those speeds, a profile with pin hole cavities generates an optimum lift. It will be appreciated that the material of the profiled element is non-absorbent, waterproof and with an underside hermetically sealed.

Still in this embodiment, the second profiled element 74 and the fourth profiled element 78 comprise cavities. The cavities comprise pin hole cavities.

The skilled addressee will appreciate that various alternative embodiments may be possible.

It will be appreciated that the illustration provided at FIG. 6a is merely exemplary and that profiled elements may be located at various other alternative places on the wingsuit 70.

Although the above description relates to a specific preferred embodiment as presently contemplated by the inventor, it will be understood that the invention in its broad aspect includes functional equivalents of the elements described herein.
Clause 1. A profiled element used for generating a force, the profiled element comprising:

a material having an active surface;

a plurality of cavities located on the active surface of the material, the plurality of cavities comprising pin holes, each pin hole having an opening of a micrometric size on the active surface and a depth of a micrometric size greater than its diameter;

wherein each pin hole is hermetically sealed on the opposite side of the cavity; and further wherein an airflow circulation against the active surface of the material causes a pressure change on the active surface and inside each of the plurality of cavities thereby generating a force.
Clause 2. The profiled element as claimed in clause 1, wherein the active surface is moving and is facing upwardly and the force generated is a lifting force oriented away from the active surface.
Clause 3. The profiled element as claimed in clause 1, wherein an active surface is facing downwardly and the force generated is a lifting force oriented toward the active surface.
Clause 4. The profiled element as claimed in clause 1, wherein the active surface is substantially perpendicular to a horizontal plane, further wherein the force is a propelling force.
Clause 5. The profiled element as claimed in clause 1, wherein the plurality of cavities comprise undulated groove cavities, further wherein the undulated groove cavities have a shape of a sinusoidal.
Clause 6. The profile element as claimed in clause 1, wherein the profiled element is in the form of surface micro irregularities made of protrusions and recesses.
Clause 7. The profiled element as claimed in clause 5, wherein the undulated groove cavities have an average crest-to-crest distance of 15 microns for relative speed comprised between 250 km/h and 400 km/h.
Clause 8. The profiled element as claimed in clause 5, wherein the undulated groove cavities have an average crest-to-crest distance comprised between 15 and 50 microns for relative speed comprised between 400 km/h and 700 km/h.
Clause 9. The profiled element as claimed in clause 5, wherein the undulated groove cavities have an average crest-to-crest distance of 50 microns for relative speed greater than 700 km/h.
Clause 10. The profiled element as claimed in any one of clauses 5, 7, 8 and 9, wherein the undulated groove cavities have a depth of 20 microns.
Clause 11. The profiled element as claimed in clause 10, wherein the ratio of openings of the pin holes cover 50% of the active surface.
Clause 12. The profiled element as claimed in any one of clauses 10 to 11, wherein at least one pin hole has an opening with a diameter value ranging from 0.2 to 1 micron for a relative speed comprised between 5 km/h and 60 km/h.
Clause 13. The profiled element as claimed in any one of clauses 10 to 11, wherein at least one pin hole has an opening with a diameter value ranging from 1 to 10 microns for a relative speed comprised between 60 km/h and 250 km/h.
Clause 14. The profiled element as claimed in any one of clauses 10 to 11, wherein at least one pin hole has an opening with a diameter value ranging from 10 to 15 microns for a relative speed comprised between 250 km/h and 400 km/h.
Clause 15. The profiled element as claimed in any one of clauses 1 to 14, wherein the airflow circulation is caused by a motion of the profiled element.
Clause 16. The profiled element as claimed in any one of clauses 1 to 14, wherein the airflow circulation is caused by air being forced against the active surface.
Clause 17. A wingsuit comprising a profiled element as claimed in any one of clauses 1 to 14.
Clause 18. An airplane comprising a profiled element as claimed in any one of clauses 1 to 14.
Clause 19. An aircraft comprising a rotating disk comprising the profiled element as claimed in any one of clauses 1 to 14.

1. A profiled element used for generating a force, the profiled element comprising:
a material having an active surface;
a plurality of cavities located on the active surface of the material, the plurality of cavities comprising pin holes, each pin hole having an opening of a micrometric size on the active surface and a depth of a micrometric size greater than its diameter;
wherein each pin hole is hermetically sealed on the opposite side of the cavity; and further wherein an airflow circulation against the active surface of the material causes a pressure change on the active surface and inside each of the plurality of cavities thereby generating a force.

2. The profiled element as claimed in claim 1, wherein the active surface is moving and is facing upwardly and the force generated is a lifting force oriented away from the active surface.

3. The profiled element as claimed in claim 1, wherein an active surface is facing downwardly and the force generated is a lifting force oriented toward the active surface.

4. The profiled element as claimed in claim 1, wherein the active surface is substantially perpendicular to a horizontal plane, further wherein the force is a propelling force.

5. The profiled element as claimed in claim 1, wherein the plurality of cavities comprise undulated groove cavities, further wherein the undulated groove cavities have a shape of a sinusoidal.

6. The profile element as claimed in claim 1, wherein the profiled element is in the form of surface micro irregularities made of protrusions and recesses.

7. The profiled element as claimed in claim 5, wherein the undulated groove cavities have an average crest-to-crest distance of 15 microns for relative speed comprised between 250 km/h and 400 km/h.

8. The profiled element as claimed in claim 5, wherein the undulated groove cavities have an average crest-to-crest distance comprised between 15 and 50 microns for relative speed comprised between 400 km/h and 700 km/h.

9. The profiled element as claimed in claim 5, wherein the undulated groove cavities have an average crest-to-crest distance of 50 microns for relative speed greater than 700 km/h.

10. The profiled element as claimed in claim 9, wherein the undulated groove cavities have a depth of 20 microns.

11. The profiled element as claimed in claim 1, wherein the ratio of openings of the pin holes cover 50% of the active surface.

12. The profiled element as claimed in claim 11, wherein at least one pin hole has an opening with a diameter value ranging from 0.2 to 1 micron for a relative speed comprised between 5 km/h and 60 km/h.

13. The profiled element as claimed in claim 11, wherein at least one pin hole has an opening with a diameter value ranging from 1 to 10 microns for a relative speed comprised between 60 km/h and 250 km/h.

14. The profiled element as claimed in claim 10, wherein at least one pin hole has an opening with a diameter value ranging from 10 to 15 microns for a relative speed comprised between 250 km/h and 400 km/h.

15. The profiled element as claimed in claim 1, wherein the airflow circulation is caused by a motion of the profiled element.

16. The profiled element as claimed in claim 1, wherein the airflow circulation is caused by air being forced against the active surface.

17. A wingsuit comprising a profiled element as claimed in claim 1.

18. An airplane comprising a profiled element as claimed in claim 1.

19. An aircraft comprising a rotating disk comprising the profiled element as claimed in claim 1.
